(19) United States
(12) Patent Application Publication
(10) Pub. No.: US 2026/0255024 A1
(43) Pub. Date: Aug. 27, 2026

(54) DYNAMICALLY SELECTED VIDEO CONTENT FOR A MULTI-PLAYER ON-LINE CONTEST

(71) Applicant: Lucrativity, LLC, Portland, OR (US)

(72) Inventor: Donald McKenney, JR., Portland, OR (US)

(73) Assignee: Lucrativity, LLC, Portland, OR (US)

(21) Appl. No.: 19/063,065

(22) Filed: Feb. 25, 2025

(51) Int. Cl. H04N 21/475; H04N 21/4784

(52) U.S. Cl. CPC H04N 21/4758; H04N 21/4784

(57) ABSTRACT

Systems and methods for conducting a multi-player on-line video contest are provided. A contest server randomly selects two videos from a pool of candidate videos for participation in a limited duration contest. A contest client presents the two selected videos to a user. The user can vote for one of the videos, or can vote for a “push.” At the end of the contest, the video receiving the votes is determined to be the winner, and the user submitting the video is awarded a prize. If the “push” option receives the most votes, or if there is a tie in the number of votes, then neither video is a winner and the prize is rolled over for the next contest.

### FIELD

The disclosure relates generally to systems and methods for a multi-player on-line contest including dynamically selected video content.

### BACKGROUND

The popularity of short videos has grown over time. Applications and video sharing platforms like TikTok, Instagram Reels, YouTube Shorts, Snapchat, and Facebook Reels provide the ability to create, share, and view user-generated short videos. While there is no strict definition, a short video is typically a user-generated video between five and ninety seconds in length.

### BRIEF DESCRIPTION OF THE DRAWINGS

For a better understanding of the inventive subject matter, reference may be made to the accompanying drawings in which:

FIG. 1 is a block diagram illustrating a system for conducting an on-line contest with dynamically selected video content according to embodiments.

FIGS. 2A-2E are conceptual diagrams illustrating a sequence of example user interface displays of a device participating in the on-line contest according to embodiments.

FIG. 3A is a flow chart illustrating server operations of a method for receiving video submissions for a multi-player on-line contest.

FIG. 3B is a flow chart illustrating server operations of a method for a multi-player on-line contest with dynamically selected video content.

FIG. 4 is a flow chart illustrating client operations of a method for a multi-player on-line contest with dynamically selected video content.

FIG. 5 is a block diagram of an example embodiment of a computer system upon which embodiments of the inventive subject matter can execute.

### DETAILED DESCRIPTION

In the following detailed description of example embodiments, reference is made to the accompanying drawings that form a part hereof, and in which is shown by way of illustration specific example embodiments in which the inventive subject matter may be practiced. These embodiments are described in sufficient detail to enable those skilled in the art to practice the inventive subject matter, and it is to be understood that other embodiments may be utilized, and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

The description of the various embodiments is to be construed as examples only and does not describe every possible instance of the inventive subject matter. Numerous alternatives could be implemented, using combinations of current or future technologies, which would still fall within the scope of the claims. The following detailed description is, therefore, not to be taken in a limiting sense, and the scope of the inventive subject matter is defined only by the appended claims.

Described herein are techniques for a multi-player on-line contest including dynamically selected short video content. The techniques include a server randomly selecting two videos. The two videos are presented to users as part of a contest to determine which of the two videos can obtain the most votes from their respective supporters (e.g., social media supporters or followers) and the public at large. The video obtaining the most votes during the contest period is declared the winner the contest jackpot.

The techniques of the disclosure include a “Push” option that can serve multiple purposes. For example, the push option facilitates voters expressing disinterest in the competing videos. Further, the push option provides an opportunity for future contestants to increase the jackpot amount, adding an extra layer of strategy and participation.

In some aspects, a contest service may schedule a contest in advance, for example, seven days. The contest service may notify the users associated with the selected videos to notify the users that their videos have been selected for the upcoming contest. A user who has a video selected for the contest can use the time before the contest begins to rally other users to vote for their video when the contest begins.

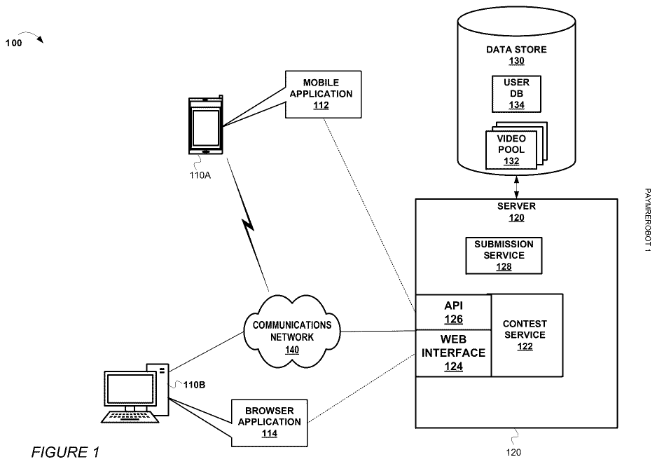

FIG. 1 is a block diagram illustrating a system 100 for conducting an on-line contest with dynamically selected video content according to embodiments. In some embodiments, system 100 includes client devices 110A and 110B, a server device 120 communicatively coupled by a communications network 140. In some aspects, the communications network 140 may be one or more networks comprising the Internet.

Client devices 110A and 110B can be any type of computing device. For example, a client device (e.g., client device 110A or 110B) can be a smartphone, tablet computer, a laptop computer, a desktop computer, navigation device, media device, smart appliance, vehicle-based communication system, an IoT device etc. In some aspects, a client device may include a display device. The display device may be any type of display device that is either integrated with the client device (e.g., as a smartphone display, laptop, or tablet computer) or a separate display device coupled with the client device, e.g., an LED display, OLED display, LCD display, a CRT, and the like. In the example shown in FIG. 1, client device 110A is a mobile device such as a smartphone and client device 110B is a desktop computer.

Server 120 may be any type of computer configured to provide services, resources, or data to other client devices (e.g., client device 110A or 110B) over the network 140. Server 120 implements a contest service 122 and may optionally provide a video submission service 128. Contest service 122 implements the techniques described herein to provide a multi-user on-line short video contest. Contest service 122 may interact with a smartphone application 112 or a browser-based application 114 via application program interface (API) 126 or web interface 124, respectively, to conduct the short video contest. Users may register with the contest service in order to be eligible to participate in the contest, either as voter or as a player. A voter is a user that can view videos in a contest and enter votes for a video. A player is a user who has submitted a candidate short video that is selected for a contest. Contest service 122 may save details regarding a user as a user profile in user database 134. Such details may include actual name, username, password, and email address. In some aspects, a user profile may include a list of videos submitted by the user and any jackpots that have been awarded to the user.

Video submission service 128 provides an interface for users to submit videos as candidates for the contest described herein. Submitted videos may be stored in a data store 130. In some aspects, submission service 128 may check a submitted video to determine if the video meets eligibility constraints for the contest. In some aspects, the submission service 128 may check to make sure a submitted video meets duration constraints. In some aspects, the duration constraint is satisfied if the video is a minimum of five seconds long and a maximum of fifteen seconds long. Other minimum and/or maximum durations may be used in other aspects. The submission service 128 may enforce other constraints. For example, the submission service may reject videos if the number of candidate videos in video pool 132 is above maximum number of candidate videos. As another example, the submission service 128 may reject a video if video pool 132 already contains a short video previously submitted by the user. Submission service 128 may assign a unique identifier to a video that meets the eligibility constraints and enter the submitted video and associated identifier to video pool 132. In some aspects, the unique identifier may be a unique numerical identifier. In addition to videos submitted for participation in the contest, other videos may also be assigned a unique identifier. For example, videos submitted for a video feed function of the application may also be assigned a unique identifier.

During operation, contest service 122 randomly selects two candidate videos from video pool 132 to participate in a short video contest. In some aspects, contest service 122 can utilize the output of a random number generator to select the two or more candidate videos. In some aspects, the contest service may use the output of the random number and the unique identifiers associated with the videos in video pool 132 to select videos for a contest. For example, the output of the random number generator may be compared with the unique identifiers associated with the videos in the video pool 132 and select the video having an identifier that is closest to the output of the random number generator. In some aspects, Chainlink VRF, available from Chainlink Labs of San Francisco, California is used to randomly select identifiers.

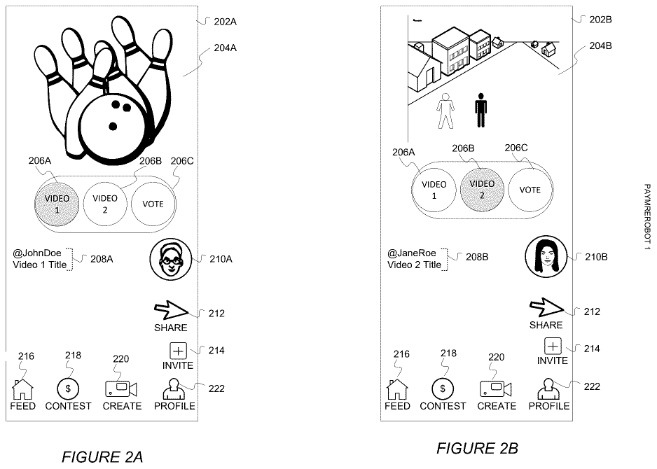

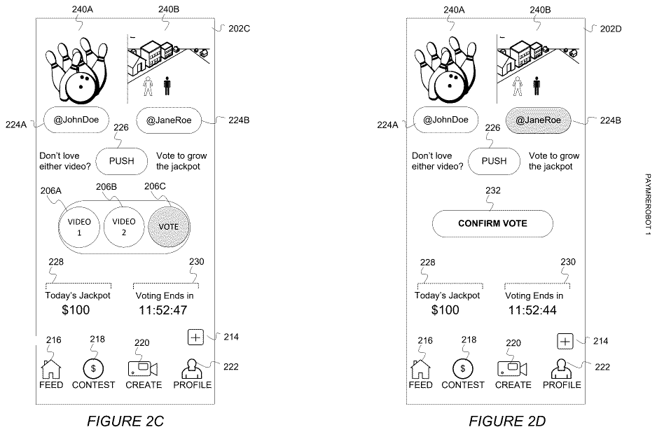

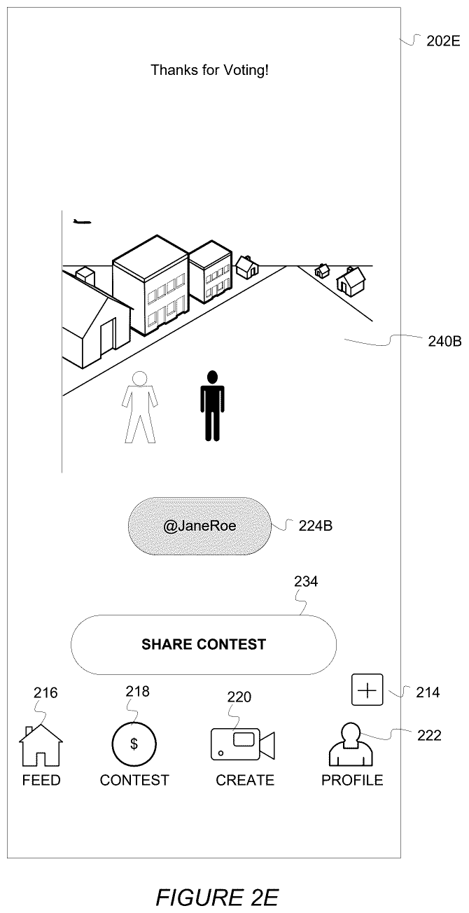

Users may view the selected videos using application 112 or 114. After viewing the videos selected for the contest, a user may submit a vote for one of the videos. FIGS. 2A-2E discussed below describe a sequence of screens presented to a user via application 112 or 114 that provide an interface for a user to view contest videos and submit votes for videos. In some aspects, a user that does not want to submit a vote for either of the selected videos may vote for a “Push.” In this case, the user is voting to have the current contest's jackpot rolled over to the next contest.

At the end of the contest, in some aspects, the contest service 122 awards a jackpot to the user associated with the video receiving the most votes. In some aspects, if the number of votes for the push option is higher than the number of votes for either of the selected videos, the contest service 122 adds the current contest's jackpot to the next contest's jackpot, and neither user is awarded the jackpot. Similarly, if the result of the voting is a tie (e.g., each of the selected videos receives the same number of votes), the contest service 122 adds the current contest's jackpot to the next contest's jackpot, and neither user is awarded the jackpot.

In some aspects, a contest may last for twenty-four hours, and the winning video (or push option) is determined at the end of the twenty-four hour period. In other aspects, a contest may be for a shorter or longer period.

In some aspects, the contest service 122 may select videos for the contest from the video pool 132 in advance of actually conducting the contest. For example, in some aspects, the contest service 122 may select video for a contest seven days in advance of the contest involving the selected videos. The contest service 122 may notify the users associated with the selected videos to notify the users that their videos have been selected for the upcoming contest. This technique facilitates the user having a video selected for the contest to rally other users to vote for their video when the contest begins. In some other aspects, the contest service 122 may select videos more or less than seven days in advance.

Although the contest described herein involves two short videos, it is noted that a contest may be between more than two videos. Further, the contest may include videos that are not short videos.

Further details on the operation of system 100 will now be provided with reference to FIGS. 2A-2E, and 3-5.

FIGS. 2A-2E are conceptual diagrams illustrating a sequence of example user interface displays of a device participating in the on-line contest according to embodiments. Various user interface elements are presented in the example displays shown in FIGS. 2A-2E. It is noted that the placement, size, shape, and orientation of these example user interface elements may differ in some implementations. Further, some of the user interface elements may be omitted in some implementations.

FIG. 2A is a conceptual diagram illustrating an example first video screen 202A of the on-line contest. In the example shown in FIG. 2A, first video screen 202A includes a video display area 204A for a first video selected for the on-line contest, selection icons 206A-206C, username and video title block 208A, a user image 210A, a share icon 212, an invite icon 214, a feed icon 216, a contest icon 218, a create icon 220, and a profile icon 222.

Display area 204A is an area of the display device of client device 110 where a contest video will be displayed. In the example of FIG. 2A, the first video may be a video of a bowling match or trick bowling. An image representing the video (e.g., a frame of the video such as a title frame) may be displayed in display area 204A when the video is not active. Although shown as placed in the upper portion of the display device, in some implementations, display area 204A may occupy a larger area of the display device, including occupying all of the display device. The indicator 206A, username and video title block 208A, user image 210A, and share icon 212 may overlap some or all of the display area 204A.

Selection indicators 206A-206C indicate where the user is in the contest flow. In the example shown in FIG. 2A, indicator 206A is highlighted to indicate that the video displayed in display area 204A is the first video for the on-line contest. When a user selects one of selection indicators 206B or 206C, the application transitions to a new screen. For example, when a user selects indicator 206B, the application transitions to a new screen that displays the second video for the current contest. When a user selects indicator 206C, the application transitions to a new screen where the user may vote for one of the two videos in the current contest, or may vote to push the jackpot to the next contest.

Username and video title block 208A can include text identifying the user submitting the first video for the on-line contest (e.g., a “player” or “contestant”) and the title of the first video. In addition, block 208A may include a player provided description of the video submitted by the player.

User image 210A can be an image representing the user that submitted the first video,

Share icon 212, when selected, provides an interface for the user to share the current contest with another person or persons via social media.

Invite icon 214, when selected, provides an interface for the user to invite another person or persons to become a user of the application.

Feed icon 216, when selected, causes the application to transition to a screen that displays a video that is not part of the current contest.

Contest icon 218, when selected, causes the application to transition to the contest. In some aspects, the application may transition to the most recently displayed contest screen. For example, if the user was viewing the second video and selects the invite icon to invite another person to become a user of the application, then when the contest icon 218 is selected, the application transitions back to the most recent contest screen, which in this example, is the screen displaying the second video.

Create icon 220, when selected, causes the application to transition to a screen and user interface that facilitates the creation of a video for submission to the pool of videos (e.g., video pool 132 of FIG. 1). The newly created video then becomes a candidate for selection to participate in a future contest.

Profile icon 222, when selected, causes the application to transition to a screen and user interface facilitating the viewing and modification of user profile details such as name, username, email address, and password. As noted above, the user profile may also include a list of videos that the user has submitted as candidates for a contest, and any prize amounts won by the user.

FIG. 2B is a conceptual diagram illustrating an example second video screen 202B of the on-line contest. In the example shown in FIG. 2B, second video screen 202B includes a video display area 204B for a second video selected for the on-line contest, username and video title block 208B, a user image 210B. Second video screen 202B also includes selection icons 206A-206C, share icon 212, invite icon 214, feed icon 216, contest icon 218, create icon 220, and profile icon 222, each of which has been described above with respect to FIG. 2A.

Display area 204B, like display area 204A, is an area of the display device of client device 110 where a contest video will be displayed. In the example of FIG. 2B, the second video may be a video showing a tour through a town. An image representing the video (e.g., a frame of the video such as a title frame) may be displayed in display area 204B when the video is not active. Although shown as placed in the upper portion of the display device, in some implementations, display area 204B, like display area 204A, may occupy a larger area of the display device, including occupying all of the display device. The indicators 206A-C, username and video title block 208B, user image 210B, and share icon 212 may overlap some or all of the display area 204B.

Username and video title block 208B can include text identifying the user submitting the second video for the on-line contest (e.g., a “player” or “contestant”) and the title of the second video. In addition, block 208B may include a player provided description of the second video.

User image 210B can be an image (e.g., photo, avatar, symbol, icon, etc.) representing the user that submitted the second video.

FIG. 2C is a conceptual diagram illustrating an example for a vote screen 202C of the on-line contest. In the example shown in FIG. 2C, vote screen 202C includes first video image 240A, second video image 240B, player 1 selection icon 224A, player 2 selection icon 224B, push selection icon 226, jackpot indicator 228 and contest end indicator 230. Vote screen 202C also includes selection icons 206A-206C, invite icon 214, feed icon 216, contest icon 218, create icon 220, and profile icon 222, each of which has been described above with respect to FIG. 2A.

First video image 240A and second video image 240B may be still images representing the first video and the second video, respectively. For example, a still image may be a frame of the video, a title image created for the video, or other representation of the video.,

Player 1 selection icon 224A and player 2 selection icon 224B are user interface elements facilitating a user vote for a video. For example, the user may select the player 1 selection icon 224A to indicate that the user wishes to submit a vote for video 1 submitted by player 1. Similarly the user may select the player 2 selection icon 224B to indicate that the user wishes to submit a vote for video 2 submitted by player 2.

Push selection icon 226 is a user interface element that, when selected by the user, indicates that the user does not wish to vote for either the first video or the second video. Instead, a vote for a push indicates that the user would like to have the contest jackpot for the current contest to be rolled over to the next contest, thereby increasing the jackpot for the next contest.

Jackpot indicator 228 displays the amount of the jackpot for the current contest. Contest end indicator 230 displays the amount of time left in the current contest.

FIG. 2D is a conceptual diagram illustrating an example vote confirmation screen 202D of the on-line contest. Vote confirmation screen 202D is similar to vote screen 202C, and includes first video image 240A, second video image 240B, player 1 selection icon 224A, player 2 selection icon 224B, push selection icon 226, jackpot indicator 228, and contest end indicator 230. Vote confirmation screen 202D also includes invite icon 214, feed icon 216, contest icon 218, create icon 220, and profile icon 222, each of which has been described above with respect to FIG. 2A.

In the example vote confirmation screen 202D, player selection icon 224B is highlighted indicating that the user selected the second video in the vote screen 202C described above with respect to FIG. 2C. Additionally, the selection icons 206A-206C have been replaced by a confirmation icon 232. User selection of confirmation icon 232 causes the application to register the user's vote and transmits an indication of the user's vote to the contest server.

FIG. 2E is a conceptual diagram illustrating an example vote completed screen 202E of the on-line contest. Vote completed screen 202E includes the video image of the video selected by the user to receive a vote. In the example of FIG. 2E, vote completed screen 202E includes second video image 240B and player 2 selection icon 224B to indicate the user has submitted a vote for the second video. Vote completed screen 202E also includes invite icon 214, feed icon 216, contest icon 218, create icon 220, and profile icon 222, each of which has been described above with respect to FIG. 2A. Vote completed screen 202E also includes share icon 234, which, when selected, provides an interface for the user to share the current contest with another person or persons via social media. In some aspects, the vote completed screen 202E may display celebratory graphics such as confetti, fireworks, etc.

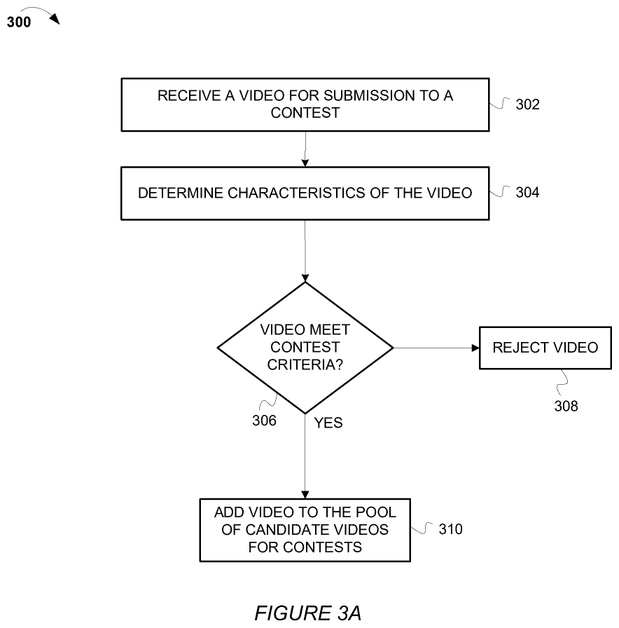

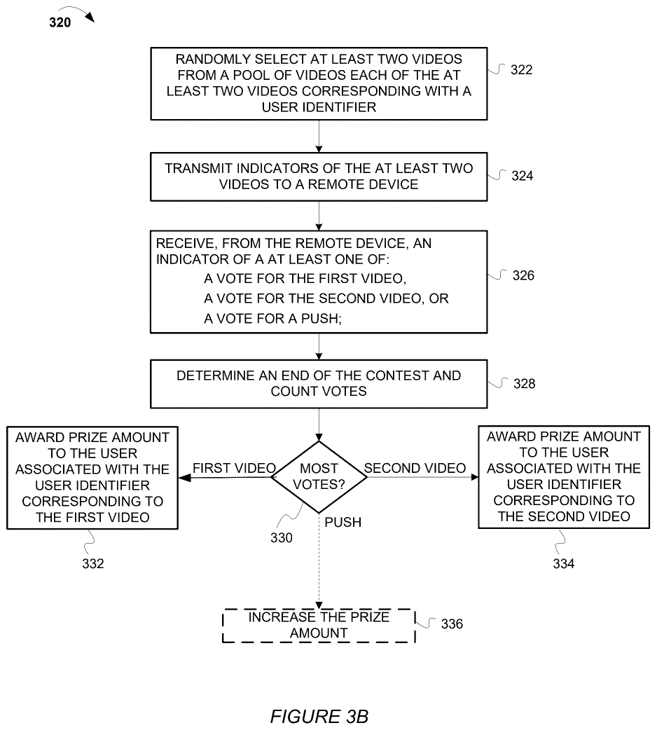

FIG. 3A is a flow chart illustrating example server operations 300 of a method for receiving video submissions for a multi-player on-line contest with dynamically selected video content. In some implementations, one or more of the operations 300 may be performed by a server such as server 120 of FIG. 1. The method may, in some aspects, constitute computer programs made up of computer-executable instructions. Describing the method by reference to a flowchart enables one skilled in the art to develop such programs including such instructions to carry out the method on suitable processors (the processor or processors of the computer executing the instructions from computer-readable media). The method illustrated in FIG. 3A is inclusive of acts that may be taken by an operating environment executing an example embodiment of the invention.

At block 302, the server receives a video for submission for the multi-player on-line contest. In some aspects, the server may receive the video from a client application (e.g., mobile application 112 or browser application 114).

At block 304, the server determines one or more characteristics of the video. For example, the server may determine a length of the video, a video format of the video, a user identification associated with the video, and the like.

At decision block 306, the server determines if the video meets criteria for the contest. In some aspects, the server may determine if the video length is within an upper bound and/or a lower bound. For example, the server may determine if the video length is between five and fifteen seconds long. In some aspects, the server may determine if there is room in the video pool (e.g., video pool 132) for the submitted video. This determination may be based on a number of videos already in the video pool, or the amount of storage available for the video pool. In some aspects, the server may determine if the video pool already contains a video previously submitted by the same user as that submitting the current video. Other criteria may be used in addition to, or instead of the above-described criteria. Further, in some aspects, the video may undergo review may an administrator to determine if the video will be accepted.

If the video meets the contest criteria (“YES” branch of decision block 306), then at block 310, the video is submitted to the video pool and becomes a candidate video for the multi-player on-line contest.

If the video fails to meet one or more of the contest criteria (“NO” branch of decision block 306), then at block 308, the server rejects the video and the video is not entered into the video pool. In some aspects, the server may notify the user submitting the video that the video was rejected, and may provide a reason for the rejection.

Although FIG. 3A shows blocks illustrating example operations 300, in some implementations, the operations 300 may include additional operations, fewer operations, different operations, or differently arranged operations than those depicted in FIG. 3. Additionally, or alternatively, two or more of the example operations 300 may be performed in parallel.

FIG. 3B is a flow chart illustrating example server operations 320 of a method for a multi-player on-line contest with dynamically selected video content. In some implementations, one or more of the operations 320 may be performed by a server such as server 120 of FIG. 1. The method may, in some aspects, constitute computer programs made up of computer-executable instructions. Describing the method by reference to a flowchart enables one skilled in the art to develop such programs including such instructions to carry out the method on suitable processors (the processor or processors of the computer executing the instructions from computer-readable media). The method illustrated in FIG. 3B is inclusive of acts that may be taken by an operating environment executing an example embodiment of the invention.

At block 322, the server selects two videos from a pool of videos. In some aspects, the server selects the two videos based on the output of a random number generator.

At block 324, the server transmits indicators of the selected videos to a remote device. In some aspects, the indicator of a video may be a unique identifier associated with the selected video. In some other aspects, the indicator may be the video itself.

At block 326, the server receives, from the remote device, an indicator of a vote. In some aspects, the indicator may indicate a vote for the first video, the second video, or for a push.

At block 328, the server determines an end of the contest. For example, in some aspects, the server determines that the contest ends twenty-four hours after the beginning of the contest. In some other aspects, a contest may end a time other than twenty-four hours after the beginning of the contest. Votes may be received and counted throughout the twenty-four hour period.

At decision block 330, the server determines which of the first video, the second video, or the push option received the most votes during the contest. If the first video received the most votes (“FIRST VIDEO” branch of decision block 330), then at block 332 the server awards the contest jackpot to the user associated with the first video. If the second video received the most votes (“SECOND VIDEO” branch of decision block 330), then at block 334 the server awards the contest jackpot to the user associated with the second video. In aspects where a push option is implemented, if the push option receives the most votes (“PUSH” branch of decision block 330), then at block 336, the server does not award either user the contest jackpot and rolls the amount of the contest jackpot over to the next contest.

Although FIG. 3B shows blocks illustrating example operations 320, in some implementations, the operations 320 may include additional operations, fewer operations, different operations, or differently arranged operations than those depicted in FIG. 3. Additionally, or alternatively, two or more of the example operations 320 may be performed in parallel.

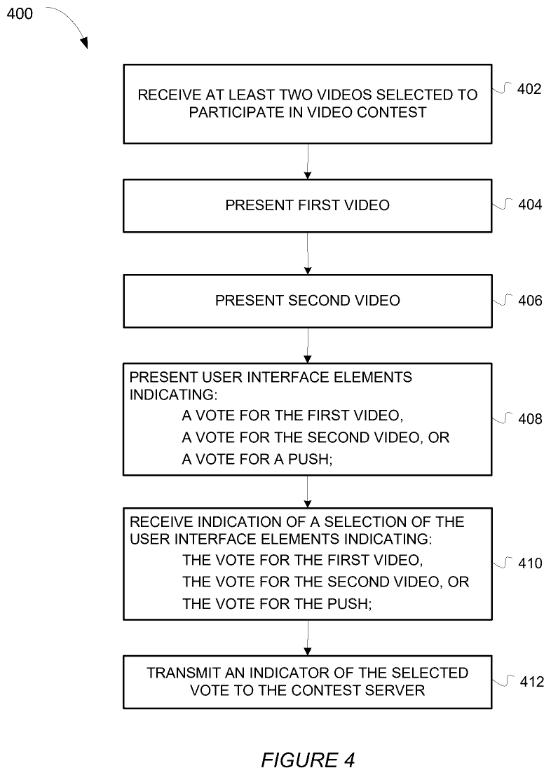

FIG. 4 is a flow chart illustrating example client operations 400 of a method for a multi-player on-line contest with dynamically selected video content. In some implementations, one or more of the operations 400 may be performed by a client device such as a smart phone, laptop computer, tablet computer, desktop computer, and the like. The method may, in some aspects, constitute computer programs made up of computer-executable instructions. Describing the method by reference to a flowchart enables one skilled in the art to develop such programs including such instructions to carry out the method on suitable processors (the processor or processors of the computer executing the instructions from computer-readable media). The method illustrated in FIG. 4 is inclusive of acts that may be taken by an operating environment executing an example embodiment of the invention.

At block 402, the client device receives two indicators for two videos of an on-line short video contest. In some aspects, an indicator of a short video may be an identifier associated with the video. The client device can then use the identifier to obtain the video content from another device such as a server (e.g., the contest server). In some aspects, the indicator of a video may be the video content itself.

At block 404, the client device presents the first video on a display of the client device. The client device may also display an interface to allow the user to navigate to the second video or to a voting screen.

At block 406, the client device presents the second video on the display of the client device. As with the first video, the client device may display the interface to allow the user to navigate to the first video or the voting screen.

At block 408, the client device presents user interface elements for receiving a vote. The user interface elements may indicate a vote for the first video, a vote for the second video, and a vote for the push option.

At block 410, the client device receives an indication of a user selection of one of the interface elements presented at block 408. In other words, the client device receives an indication of a vote for the first video, a vote for the second video, or a vote for the push option.

At block 412, the client device transmits an indicator of the selected vote to the contest server.

Although FIG. 4 shows blocks illustrating example operations 400, in some implementations, the operations 400 may include additional operations, fewer operations, different operations, or differently arranged operations than those depicted in FIG. 4. Additionally, or alternatively, two or more of the example operations 400 may be performed in parallel.

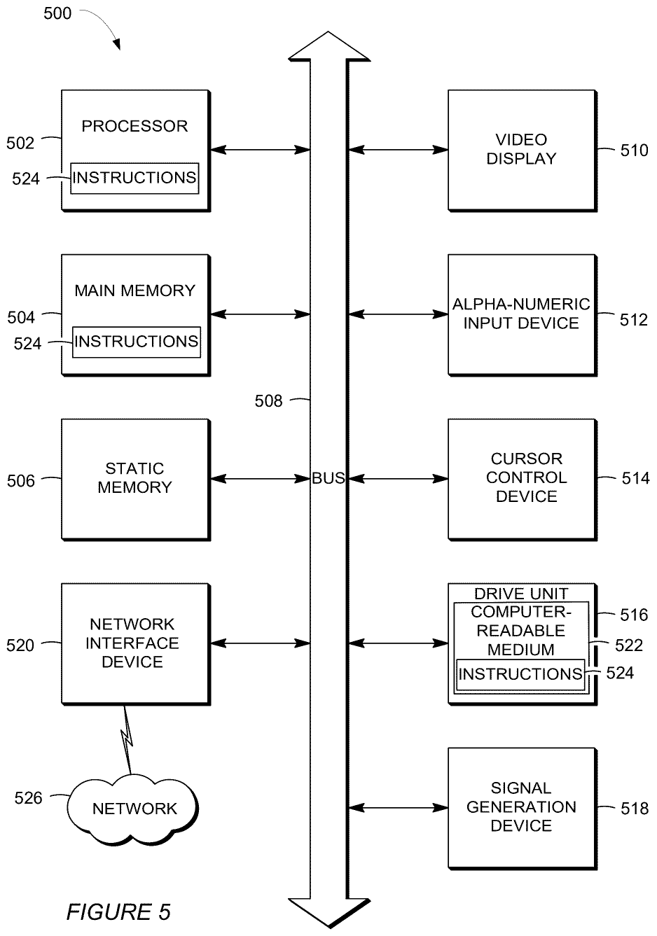

FIG. 5 is a block diagram of an example embodiment of a computer system upon which embodiments of the inventive subject matter can execute. The description of FIG. 5 is intended to provide a brief, general description of suitable computer hardware and a suitable computing environment in conjunction with which the invention may be implemented. In some embodiments, the inventive subject matter is described in the general context of computer-executable instructions, such as program modules, being executed by a computer. Generally, program modules include routines, programs, objects, components, data structures, etc., that perform particular tasks or implement particular data types.

As indicated above, the system as disclosed herein can be spread across many physical hosts. Therefore, many systems and sub-systems of FIG. 5 can be involved in implementing the inventive subject matter disclosed herein.

Moreover, those skilled in the art will appreciate that the invention may be practiced with other computer system configurations, including hand-held devices, multiprocessor systems, microprocessor-based or programmable consumer electronics, smart phones, network PCs, minicomputers, mainframe computers, and the like. Embodiments of the invention may also be practiced in distributed computer environments where tasks are performed by I/O remote processing devices that are linked through a communications network. In a distributed computing environment, program modules may be located in both local and remote memory storage devices.

With reference to FIG. 5, an example embodiment extends to a machine in the example form of a computer system 500 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 500 may include a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). In example embodiments, the computer system 500 also includes one or more of an alpha-numeric input device 512 (e.g., a keyboard), a user interface (UI) navigation device or cursor control device 514 (e.g., a mouse), a disk drive unit 516, a signal generation device 518 (e.g., a speaker), and a network interface device 520.

The disk drive unit 516 includes a machine-readable medium 522 on which is stored one or more sets of instructions 524 and data structures (e.g., software instructions) embodying or used by any one or more of the methodologies or functions described herein. The instructions 524 may also reside, completely or at least partially, within the main memory 504 or within the processor 502 during execution thereof by the computer system 500, the main memory 504 and the processor 502 also constituting machine-readable media.

While the machine-readable medium 522 is shown in an example embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media that can store information in a non-transitory manner, i.e., media that is able to store information. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 524 may further be transmitted or received over a communications network 526 using a signal transmission medium via the network interface device 520 and utilizing any one of a number of well-known transfer protocols (e.g., FTP, HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “machine-readable signal medium” shall be taken to include any transitory intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

As is evident from the foregoing description, certain aspects of the inventive subject matter are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the inventive subject matter. Therefore, it is manifestly intended that this inventive subject matter be limited only by the following claims and equivalents thereof.

The Abstract is provided to comply with 37 C.F.R. § 1.72(b) to allow the reader to quickly ascertain the nature and gist of the technical disclosure. The Abstract is submitted with the understanding that it will not be used to limit the scope of the claims.

Having thus described the invention, what is claimed as new and desired to be secured by Letters Patent is:

1. A method for conducting a contest, the method comprising:
randomly selecting, by one or more processors, at least two videos from a plurality of videos maintained in a computer readable data store, the at least two videos including a first video and a second video, each of the at least two videos corresponding with a user identifier;
transmitting, by the one or more processors, at least a first indicator corresponding to the first video and a second indicator corresponding to the second video to a remote device;
receiving, by the one or more processors from the remote device, a third indicator indicating a at least one of:
a vote for the first video,
a vote for the second video, or
a vote for a push;
determining, by the one or more processors, an end of the contest;
awarding, by the one or more processors, a prize amount to a user associated with the user identifier corresponding to the first video when, at the end of the contest, a count of votes for the first video is greater than a count of votes for the second video and a count of votes for the push;
awarding, by the one or more processors, the prize amount to a user associated with the user identifier corresponding to the second video when, at the end of the contest, the count of the votes for the second video is greater than the count of the votes for the first video and the count of the votes for the push; and
increasing, by the one or more processors, the prize amount when, at the end of the contest, the count of the votes for the push is greater than the count of the votes for the first video and the count of the votes for the second video.

2. The method of claim 1, wherein the video comprises a short video having a time duration that is at least one of:
above a threshold minimum duration; or
below a threshold maximum duration.

3. The method of claim 2, wherein the time duration is in a range of five to fifteen seconds.

4. The method of claim 1, further comprising:
assigning, by the one or more processors, a unique video identifier to each of the plurality of videos;
wherein the randomly selecting the at least two videos comprises selecting the at least two videos based on output of a random number generator, the unique identifier of the first video, and the unique identifier of the second video.

5. The method of claim 1, further comprising:
receiving a candidate video;
determining if the candidate video complies with one or more contest constraints; and
adding the candidate video to the plurality of videos when the candidate video satisfies the one or more contest constraints.

6. The method of claim 5, wherein the one or more contest constraints comprise a time limit.
The method of claim 1, further comprising delaying the transmitting the at least two videos by a delay period after randomly selecting the at least two videos.

8. The method of claim 1, further comprising sending a notification to a first user having the user identifier corresponding to the first video and a second user having the user identifier corresponding to the second video that the first video and second video have been selected for the contest and a date of a beginning of the contest.

9. An apparatus for conducting a contest comprising:
one or more processors; and
a contest service executable by the one or more processors, the contest service configured to:
randomly select at least two videos from a plurality of videos maintained in a computer readable data store, the at least two videos including a first video and a second video, each of the at least two videos corresponding with a user identifier,
transmit at least a first indicator corresponding to the first video and a second indicator corresponding to the second video to a remote device;
receive a third indicator indicating a at least one of:
a vote for the first video,
a vote for the second video, or
a vote for a push;
determine an end of the contest,
award a prize amount to a user associated with the user identifier corresponding to the first video when, at the end of the contest, a count of votes for the first video is greater than a count of votes for the second video and a count of votes for the push,
award the prize amount to a user associated with the user identifier corresponding to the second video when, at the end of the contest, the count of the votes for the second video is greater than the count of the votes for the first video and the count of the votes for the push, and
increase the prize amount when, at the end of the contest, the count of the votes for the push is greater than the count of the votes for the first video and the count of the votes for the second video.

10. The apparatus of claim 9, wherein the video comprises a short video having a time duration that is at least one of:
above a threshold minimum duration; or
below a threshold maximum duration.

11. The apparatus of claim 10, wherein the time duration is in a range of five to fifteen seconds.

12. The apparatus of claim 9, wherein the contest service is further configured to:
assign a unique video identifier to each of the plurality of videos; and
select the at least two videos based on output of a random number generator, the unique identifier of the first video, and the unique identifier of the second video.

13. The apparatus of claim 9, further comprising a submission service configured to:
receive a candidate video;
determine if the candidate video complies with one or more contest constraints; and
add the candidate video to the plurality of videos when the candidate video satisfies the one or more contest constraints.

14. The apparatus of claim 13, wherein the one or more constraints comprise a time limit.

15. The apparatus of claim 9, wherein the contest service is further configured to delay the transmission of the at least two videos by a delay period after the random selection of the at least two videos.

16. The apparatus of claim 9, wherein the contest service is further configured to send a notification to a first user having the user identifier corresponding to the first video and a second user having the user identifier corresponding to the second video that the first video and second video have been selected for the contest and a date of a beginning of the contest.

17. A computer-readable medium having stored thereon computer executable instructions for conducting a contest, that, when executed, cause one or more processors to:
randomly select at least two videos from a plurality of videos maintained in a computer readable data store, the at least two videos including a first video and a second video, each of the at least two videos corresponding with a user identifier;
transmit at least a first indicator corresponding to the first video and a second indicator corresponding to the second video to a remote device;
receive a third indicator indicating a at least one of:
a vote for the first video,
a vote for the second video, or
a vote for a push;
determine an end of the contest;
award a prize amount to a user associated with the user identifier corresponding to the first video when, at the end of the contest, a count of votes for the first video is greater than a count of votes for the second video and a count of votes for the push;
award the prize amount to a user associated with the user identifier corresponding to the second video when, at the end of the contest, the count of the votes for the second video is greater than the count of the votes for the first video and the count of the votes for the push; and
increase the prize amount when, at the end of the contest, the count of the votes for the push is greater than the count of the votes for the first video and the count of the votes for the second video.

18. A method for a contest application, the method comprising:
receiving, by one or more processors, at least two indicators corresponding to at least two videos for display on a device hosting the contest application, each of the at least two videos corresponding with a different user identifier, the at least two videos including a first video and a second video;
presenting the first video on the display;
presenting the second video on the display;
presenting, on the display, a user interface including at least:
a first user interface element indicating a vote for the first video,
a second user interface element indicating a vote for the second video, or
a third user interface element indicating a vote for a push;
receiving at least one of:
a first indication of a user selection of the first user interface element,
a second indication of a user selection of the second user interface element, or
a third indication of a user selection of the third user interface element; and
transmitting, to a contest server, at least one of
the first indication of the selection of first user interface element,
the second indication of the selection of the second user interface element, or
the third indication of the selection of the third user interface element.
